(19) United States
(12) Patent Application Publication
(10) Pub. No.: US 2018/0175359 A1
(43) Pub. Date: Jun. 21, 2018

(54) METHOD FOR PRODUCING AN ELECTROCHEMICAL BUNDLE FOR A METAL-ION ACCUMULATOR COMPRISING METAL FOAM AT THE ENDS OF FOILS

(71) Applicant: COMMISSARIAT A L'ENERGIE ATOMIQUE ET AUX ENERGIES ALTERNATIVES, Paris (FR)

(72) Inventor: Olivier MASSON, Sassenage (FR)

(73) Assignee: COMMISSARIAT A L'ENERGIE ATOMIQUE ET AUX ENERGIES ALTERNATIVES, Paris (FR)

(21) Appl. No.: 15/738,872

(22) PCT Filed: Jun. 21, 2016
(86) PCT No.: PCT/EP2016/064293

§ 371 Date: Dec. 21, 2017

(30) Foreign Application Priority Data
Jun. 22, 2015 (FR) 1555698

(51) Int. Cl. H01M 2/26; H01M 4/133; H01M 4/136; H01M 4/131; H01M 10/0525; H01M 10/04; H01M 10/0587

(52) U.S. Cl. CPC H01M 2/263; H01M 4/133; H01M 4/136; H01M 10/0587; H01M 10/0525; H01M 10/0422; H01M 10/0431; H01M 4/131

(57) ABSTRACT

One subject of the invention is a process for producing an electrochemical bundle of a metal-ion accumulator, with a view to its electrical connection to the output terminals of the accumulator, which is characterized by the addition of a strip of metal foam to the margins with a view to welding with a current collector.

### TECHNICAL FIELD

The present invention relates to the field of metal-ion electrochemical generators, which operate according to the principle of insertion or deinsertion, or in other words intercalation/deintercalation, of metal ions in at least one electrode.

More particularly it relates to a metal-ion electrochemical accumulator including at least one electrochemical cell consisting of an anode and a cathode on either side of a separator impregnated with electrolyte, two current collectors one of which is connected to the anode and the other to the cathode, and a casing of a shape that is elongate along a longitudinal axis (X), the casing being arranged to sealably house the electrochemical cell even though a portion of the current collectors forming output terminals, also referred to as poles, passes therethrough.

The separator may consist of one or more films.

The casing may include a cover and a container, usually referred to as a can, or include a cover, a bottom and a lateral jacket joined both, to the bottom and to the cover.

The present invention aims to produce an electrical connection portion between at least one electrochemical cell of the accumulator and its output terminals integrated into its casing.

Although described with reference to a lithium-ion accumulator, the invention is applicable to any metal-ion electrochemical accumulator, i.e. also to sodium-ion accumulators, magnesium-ion accumulators, aluminium-ion accumulators, etc.

### PRIOR ART

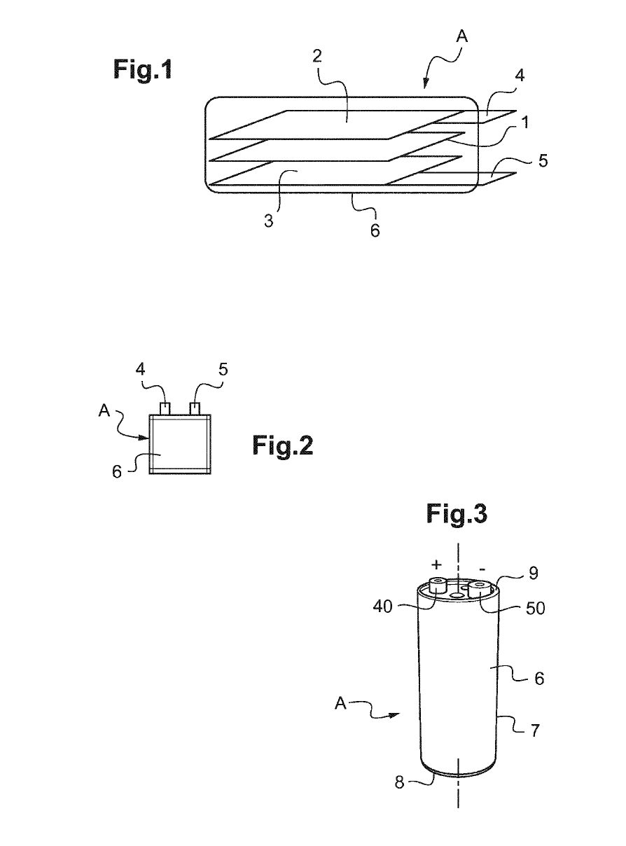

Such as schematically illustrated in FIGS. 1 and 2, a lithium-ion accumulator or battery usually includes at least one electrochemical cell C consisting of a separator impregnated with a constituent electrolyte 1 between a positive electrode or cathode 2 and a negative electrode or anode 3, a current collector 4 connected to the cathode 2, a current collector 5 connected to the anode 3 and lastly, a packaging 6 arranged to sealably contain the electrochemical cell even though a portion of the current collectors 4, 5, forming the output terminals, passes therethrough.

The architecture of conventional lithium-ion batteries is an architecture that may be qualified monopolar, because with a single electrochemical cell including an anode, a cathode and an electrolyte. A number of types of monopolar architecture geometry are known:

a cylindrical geometry such as disclosed in patent application US 2006/0121348;

a prismatic geometry such as disclosed in patents U.S. Pat. No. 7,348,098 and U.S. Pat. No. 7,338,733; and

a stacked geometry such as disclosed in patent applications US 2008/060189 and US 2008/0057392 and patent U.S. Pat. No. 7335448.

The electrolyte constituent may be a solid, liquid or gel. In the latter form, the constituent may comprise a separator made of a polymer or microporous composite imbibed with organic or liquid-ionic electrolyte(s) that allow(s) lithium ions to move from the cathode to the anode for a charge and vice versa for a discharge, thereby generating the current. The electrolyte is in general a mixture of organic solvents, for example of carbonates, to which a lithium salt, typically LiPF6, is added.

The positive electrode or cathode consists of insertion materials of the lithium cation which are in general composites, such as lithium iron phosphate LiFePO₄, lithium cobalt oxide LiCoO₂, optionally substituted lithium manganese oxide LiMn₂O₄ or a material based on LiNiₓMn_{y}Co_{z}O₂ where x+y+z=1, such as LiNi_{0.33}Mn_{0.33}Co_{0.33}O₂, or a material based on LiNiₓCo_{y}Al_{z}O₂ where x+y±z=1, LiMn₂O₄, LiNiMnCoO₂ or lithium nickel cobalt aluminium oxide LiNiCoAlO₂.

The negative electrode or anode very often consists of carbon, graphite or is made of Li₄TiO₅O₁₂ (titanate material), though also optionally is based on silicon or based on lithium, or based on tin and alloys thereof or of a silicon-based composite.

The anode and the cathode made of lithium insertion material may be deposited using a conventional technique in the form of an active layer on a metal sheet forming a current collector.

The current collector connected to the positive electrode is in general made of aluminium.

The current collector connected to the negative electrode is in general made of copper, of nickel-coated copper or of aluminium.

Conventionally, a Li-ion accumulator or battery uses a pair of materials at the anode and at the cathode that allow it to operate at a high voltage level, typically about 3.6 volts.

A Li-ion accumulator or battery includes a rigid packaging or casing when the targeted applications are constraining or a long lifetime is sought, with for example very high pressures to be withstood and a requirement for a stricter seal-tightness level (typically lower than 10⁻⁶ mbar.l/s helium), or in highly constraining environments such as in the spatial or aeronautic field.

The main advantage of rigid packagings is thus that their high seal tightness is maintained over time because the casings are closed by welding, in general by laser welding.

The geometry of most rigid packaging casings of Li-ion accumulators is cylindrical, because most accumulator electrochemical cells are wound by spooling into a cylindrical geometry. Casings of prismatic shapes have also already been produced. One of the types of cylindrically shaped rigid casings usually manufactured for high-capacity Li-ion accumulators of lifetime longer than 10 years is illustrated in FIG. 3.

The casing 6, of longitudinal axis X, includes a cylindrical lateral jacket 7, a bottom 8 at one end, and a cover 9 at the other end. The cover 9 bears the terminals or poles 40, 50 through which the current is output. One of the output terminals (poles), for example the positive terminal 40, is welded to the cover 9, whereas the other output terminal, for example the negative terminal 50, passes through the cover 9 with interposition of a seal (not shown) that electrically insulates the negative terminal 50 from the, cover.

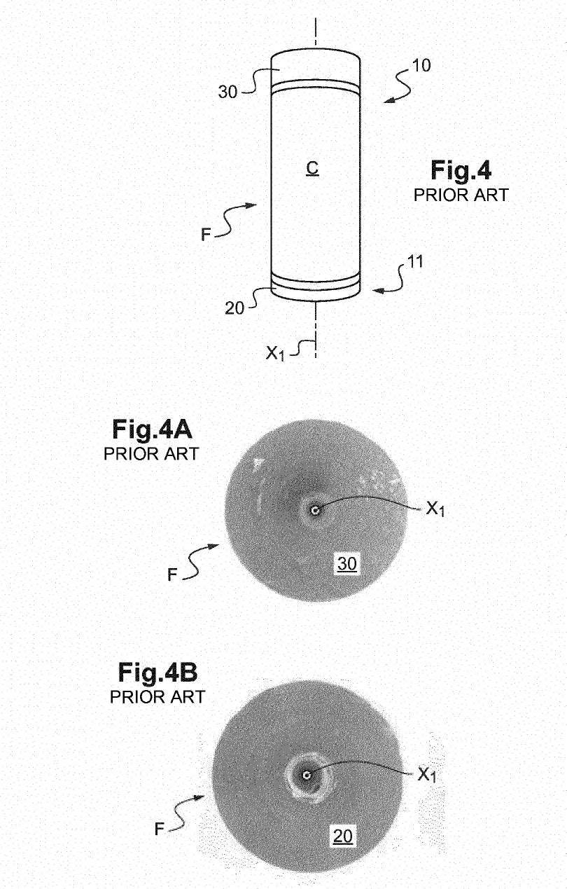

FIGS. 4 to 4B show reproductions of photographs of an electrochemical bundle F of a shape that is elongate along a longitudinal axis X1, and including a single electrochemical cell C such as it usually is wound by spooling before the steps of housing in a casing and of electrical connection to the output terminals of the accumulator, and its impregnation with an electrolyte. The cell C consists of an anode 3 and a cathode 4 on either side of a separator (not shown) suitable for being impregnated with electrolyte. As may be seen, one 10 of its lateral ends of the bundle F is bounded by uncoated bands 30 of anode 3, whereas the other 11 of its lateral ends is bounded by uncoated bands 20 of cathode 2.

The expression “uncoated bands” is here and in the context of the invention understood to mean the portions of the metal sheets, also referred to as foils, forming the current collectors, that are not covered with a lithium insertion material.

The objective of manufacturers of accumulators is to increase the discharge time of a cell of the accumulator, or their aptitude to be able to operate in high-power regimes, while improving their lifetime, i.e. the number of times they may be cycled, their lightness and the cost of manufacturing these components.

Approaches to improving Li-ion accumulators mainly address the nature of the materials and the methods used to produce electrochemical-cell components.

Other less common possible approaches to improvement address the casings of accumulators and the methods and means used to electrically connect an electrochemical bundle to the two output terminals, also referred to as caps or even poles, of different polarity of the accumulator.

At the present time, when it is desired to produce a high-quality electrical connection between the electrochemical bundle and the output terminals of a Li-ion accumulator of cylindrical or prismatic geometry, it is sought to respect as best as possible the following design rules:

meet the requirements of an application in terms of electrical conduction between each polarity of electrode and the output terminals integrated into the casing of the accumulator, for example with a view to responding to peaks in power while limiting heating inside the accumulator liable to accelerate its electrochemical aging;

minimize the level of the overall internal resistance of the accumulator by making the electrical connection directly to the current collectors of the electrodes for each polarity and by, connecting an intermediate connection part between the electrochemical bundle and the casing of the accumulator;

simplify the connection to the electrochemical bundle, by making the connection directly to the lateral uncoated electrode bands (also referred to as margins) bounding the two opposite lateral ends of the bundle, respectively;

optimize the characteristics (thickness, height, weight) and profiles of the lateral uncoated electrode bands for making said electrical connection, in order to as best as possible meet the requirements of the final assembly steps, i.e. the steps of integration of the electrochemical bundle into the casing, of closing the casing of the accumulator, of filling with electrolyte, etc.; and

minimize the mass and volume required to make the electrical connection which as such is not a generator of electrochemical energy, but that are necessary to transfer energy from the electrochemical bundle to the exterior of the accumulator casing.

Regarding the literature describing solutions for producing electrochemical bundles for accumulators of cylindrical or prismatic shape and the electrical connection thereof to output terminals integrated into the casings thereof, mention may be made of the following documents.

Patent application WO 2015/0311541 discloses welding tabs to the uncoated bands of an electrochemical bundle.

Patent FR 2094491 discloses an alkaline accumulator the electrical connection of which between the wound electrochemical cell and output terminals is obtained by cutting regularly spaced slits in the margins of the electrodes, then radially folding the margins thus slit from the exterior of the interior, the margins then taking the form of superposed lamina forming a substantially flat plinth to which a current collector that, depending on the circumstances, may consist of the cover of the casing, is lastly welded.

Patent application EP 1102337 discloses a Li-ion accumulator the electrical connection of which between the wound electrochemical cell and output terminals is obtained by pressing once each end of the electrode foils of the wound cell, along the winding axis, by means of a pressing tool then, by laser welding of each end of the electrode layers to a terminal current collector consisting of a foil taking the form of a disk and a connecting tab itself subsequently laser welded to the cover of the casing, at one end, and to the casing bottom, at the other end. Ribs are produced each over a diameter of the disk and are themselves pressed before the welding against the pressed electrode foil ends.

Patent application EP 1596449 describes a Li-ion accumulator the electrical connection of which between the wound electrochemical cell and output terminals is obtained firstly by multiple pressing of each lateral end bounded by uncoated electrode bands of the wound cell, by means of a pressing tool of outside diameter comprised between 15 and 20 mm. The pressing tool moves over a very small distance alternatively from the exterior toward the interior of the cell parallel to the winding axis while travelling round the entire lateral area of the uncoated electrode bands in order to make the latter overlap and form a dense flat plinth to which is laser or transparency welded a terminal current collector consisting of a foil taking the form of a flat connection band itself laser or transparency welded subsequently to an output terminal integrated into the cover at one lateral end and to the casing bottom, at the other lateral end.

By analyzing all the known solutions for producing an electrochemical bundle of a lithium accumulator and its electrical connection to the output terminals of the accumulator, such as described above, the inventors came to the conclusion that said solutions were still perfectible in many ways.

Firstly, the weight and volume of the lateral uncoated electrode bands (margins) required for the electrical connection with the current collectors according to the prior art are not necessarily optimized, thereby implying that the weight and volume of the accumulator will in the end also not be optimized.

Next, the inventors observed that de facto the margins of a given lateral end were not necessarily electrically connected together, in particular those portions of these margins which are located in the most peripheral zone of the bundle. This implies an increase in the path length to be travelled by the current to reach certain zones of the bundle, thus increasing the internal resistance of these zones. This therefore creates non-uniformities in current distribution, this possibly being, disadvantageous in particular for high-power applications of the accumulator.

Lastly, the step of filling a lithium accumulator electrochemical bundle with electrolyte may prove to be relatively long and tricky because the current collectors according to the prior art, such as they are welded to the accumulator electrochemical bundle margins, form a substantial obstacle to the passage of the electrolyte.

To mitigate these drawbacks, the applicant proposed in the patent application FR 3011128 A1 a new process for producing an electrochemical bundle, this process comprising a combination of two steps b/ and c/ of folding an electrochemical bundle, which steps were distinct in their implementation and allowed two distinct zones to be obtained on at least one, and, preferably each, of the lateral ends of the bundle.

This process is particularly effective in terms of electrical conductivity and removal of heat from the bundle.

However, its implementation may prove to be constraining in certain applications.

Thus, existing techniques for producing accumulator electrochemical bundles and their electrical connection to their output terminals and the drawbacks of such techniques may be classed into two categories:

forming the bundle by spooling then placing/welding tabs directly on the spooled bundle. This technique is relatively easy to implement, but ineffective in terms of electrical conductivity and removal of heat from the bundle;

forming the bundle by spooling then carrying out operations in order to tamp down/compact the spooled bundle. This technique, which consists in increasing the density of the uncoated lateral bands (margins) is effective in terms of electrical conductivity and removal of the heat from the bundle, but more complicated to implement.

There is therefore a need to improve the production of the electrochemical bundle of a lithium accumulator (and more generally of a metal-ion accumulator) and its electrical connection to the output terminals of the accumulator, especially with a view to simplifying its implementation while preserving a good performance in terms of electrical conductivity and removal of the heat from the bundle.

The aim of the invention is to at least partially meet this need.

### SUMMARY OF THE INVENTION

To this end, the invention relates, under one of its aspects, to a process for producing an electrochemical bundle (F) of a metal-ion accumulator (A), such as a Li-ion accumulator, with a view to its electrical connection to the output terminals of the accumulator, including the following steps:

a/ welding a strip of metal foam to at least one face of one or more uncoated bands of the anode and/or cathode of at least one electrochemical cell (C) that consists of the cathode and anode on either side of a separator suitable for being impregnated with an electrolyte;

b/ winding upon itself by spooling the electrochemical cell until an electrochemical bundle having a shape that is elongate along a longitudinal axis X is formed with, at one of its lateral ends, uncoated bands of anode, and, at the other of its lateral ends, uncoated bands of cathode, the one or more metal foams welded to the one or more faces of the one or more bands and that are adjacent to one another forming a substantially flat plinth that is intended to be welded to a current collector.

Thus, the process according to the invention is characterized by the addition of a strip of metal foam to the margins with a view to welding with a current collector

The strip of metal foam has a thickness chosen to sufficiently fill the space between two spool turns during the formation of the bundle by winding upon itself. Of course, the metal chosen for the foam strip will be compatible with the welding and, preferably, identical to that of;the electrode to which it will be welded, and that will also be compatible with the electrochemical potential of the electrode in order to prevent oxidation of the metal foam. The metal foam may thus be made of copper, of aluminium, of steel, of nickel, etc.

Once the bundle has been spooled, all the adjacent foam portions form a metal mattress over a substantial portion or even the entirety of the area at the end of the bundle, thereby making it possible to achieve a high-quality weld of the positive and negative collectors in the zones thus prepared.

The metal mattress obtained in this way is uniform over all the end area(s) of the electrochemical bundle.

The assembly consisting of a strip of metal foam according to the invention and spooled foil as an end that is dense enough to accept laser welding. The heat delivered by the welding may spread and avoid burning the collectors, while creating a good quality electrical joint. Furthermore, using foam is an advantage in the subsequent phases of filling with electrolyte, because the pores present in the foam do not obstruct the passage of the electrolyte enough to prevent filling.

The process according to the invention may be implemented with electrodes the metal foil of which is relatively thin or relatively thick in the case where the accumulator is intended for a power application.

The process according to the invention makes it possible to dispense with techniques for axially tamping down the electrochemical bundle, which, although they certainly allow a good performance to be obtained in terms of electrical conductivity and heat removal from the bundle, are not necessarily simple to implement.

The process according to the invention is therefore both simple to implement and guarantees a good performance in terms of electrical conductivity and heat removal from the bundle.

The process according to the invention may advantageously be implemented to produce Li-ion batteries or accumulators.

According to one advantageous variant, steps a/ and b/ are carried out continuously, step a/ being carried out prior to step b/.

Placing and welding the strip of metal foam continuously before the bundle is spooled is advantageous because this ensures the time required to produce the bundle is not increased with respect to the known technique. In other words, this time, which would otherwise be lost, is saved by parallel processing. In other words, this makes it possible to avoid having to manage any additional processing steps, such as implemented in another machine. Specifically, it is enough to modify existing equipment for unwinding a spool of electrode metal foil, depositing a layer of active insertion material, in particular by coating, and winding the electrodes, by adding thereto, upstream, a station in which one or more strips of metal foam are placed and welded simultaneously and continuously with the unwinding of the electrode metal foil.

The step a/ of welding may be carried out by electric, laser or ultrasonic welding. Whatever the chosen technique, it must make it possible to guarantee cohesion between the one or more foam strips and the one or more bands of the metal foils during the spooling of the bundle and during the welding to the current collectors.

The step a/ of welding may also be carried out by laser beam, continuously during the unwinding of electrode foil. The laser may then be moved with respect to the electrode foil. The laser beam may be a continuous line throughout the unwinding of the electrode foil, controlled to synchronize it with the run speed of the electrode foil and/or the run speed of the foam strip, or even a succession of pulses of the laser, which succession may also be controlled dependent on the run speed of the electrode foil and/or of the strip of metal foam.

The step a/ of welding may also be a step of spot welding or a step of welding along a continuous path, i.e. along one or more continuous lines or in one or more continuous patterns. When the welding is spot welding, the number of spots and their relative spacing are adjusted depending on each desired accumulator design.

Alternatively, the step a/ may advantageously be a step of continuous ultrasonic welding, using processes that are very commonplace in the manufacture of waterproof clothing. In these processes, a roller places at the same time the two elements to be welded under pressure and also creates the ultrasonic weld continuously. With respect to a laser-welding solution such as detailed above, excessive crushing of the foam must be avoided if it is to return to its original shape on being output from the process.

Preferably, the one or more foam strips are made from a material that is compatible with, and more preferably from the same material as, that of the one or more uncoated bands to which they are welded.

According to one advantageous variant, a strip of metal foam may be welded to each of the two faces of the uncoated bands of the anode and/or cathode.

The process may include a step c/ consisting of an axial compression along the X-axis of the bands of the electrochemical bundle, in at least one area comprising the one or more strips of metal foam at the end of the uncoated bands so as to obtain, in the compressed area portion, the substantially flat plinth intended to be welded to a current collector.

Yet another subject of the invention is a process for producing a portion for electrical connection between an electrochemical bundle of a metal-ion accumulator and one of the output terminals of the accumulator, including the following steps:

producing an electrochemical bundle using the process described above;

welding each plinth formed by the one or more strips of metal foam to a current collector itself intended to be electrically connected or joined to an output terminal of the accumulator.

Advantageously, the step of welding a plinth to a current collector is carried out by laser welding.

Lastly, the invention relates to a metal-ion accumulator or battery including a casing including:

a bottom to which is welded one or more current collectors welded to the electrochemical bundle using the process described above; and

a cover with a feedthrough forming an output terminal to which is welded the other of the current collectors welded to the electrochemical bundle using the process described above.

Preferably, for a Li-ion accumulator or a casing:

the material of the negative electrodes) is chosen from the group including graphite, lithium, titanate oxide Li₄TiO₅O₁₂; or based on silicon or based on lithium, or based on tin and alloys thereof;

the material of the positive electrode(s) is chosen from the group including lithium iron phosphate LiFePO₄, lithium cobalt oxide LiCoO₂, optionally substituted lithium manganese oxide LiMn₂O₄ or a material based on LiNixMnyCozO₂ where x+y+z=1, such as LiNi_{0.33}Mn_{0.33}Co_{0.33}O₂, or a material based on LiNixCoyAlzO₂ where x+y+z=1, LiMn₂O₄, LiNiMnCoO₂ or lithium nickel cobalt aluminium oxide LiNiCoAlO₂.

### DETAILED DESCRIPTION

Other advantages and features of the invention will become more clearly apparent on reading the detailed description of examples of implementation of the invention, which nonlimiting description is given by way of illustration with reference to the following figures, in which:

FIG. 1 is an exploded schematic perspective view showing the various elements of a lithium-ion accumulator;

FIG. 2 is a front view showing a lithium-ion accumulator with its flexible packaging according to the prior art;

FIG. 3 is a perspective view of a lithium-ion accumulator according to the prior art with its rigid packaging consisting of a casing;

FIG. 4 is a perspective view of an electrochemical bundle of a lithium-ion accumulator according to the prior art, the bundle consisting of a single electrochemical cell wound upon itself by spooling;

FIG. 4A is a photographic top view of one lateral end of the electrochemical bundle in FIG. 4;

FIG. 4B is a photographic top view of the other lateral end of the electrochemical bundle in FIG. 4;

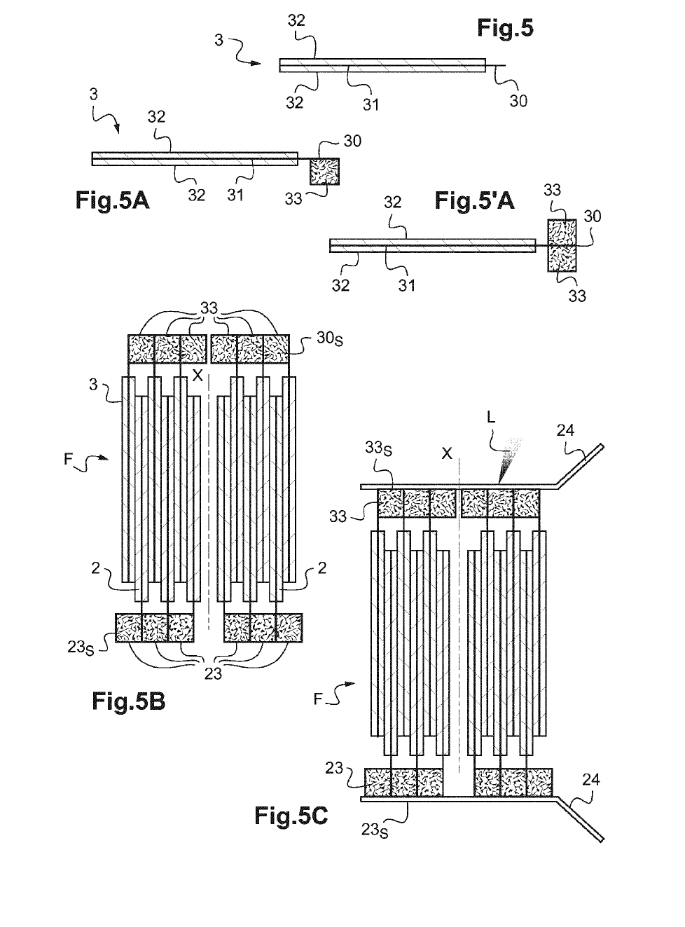

FIGS. 5 to 5C are schematic views showing the successive steps of an example according to the invention of a process for producing, an electrochemical bundle and a portion for electrical connection thereof to the output terminals of the accumulator that it is integrated into, FIG. 5′A being a variant of FIG. 5A; and

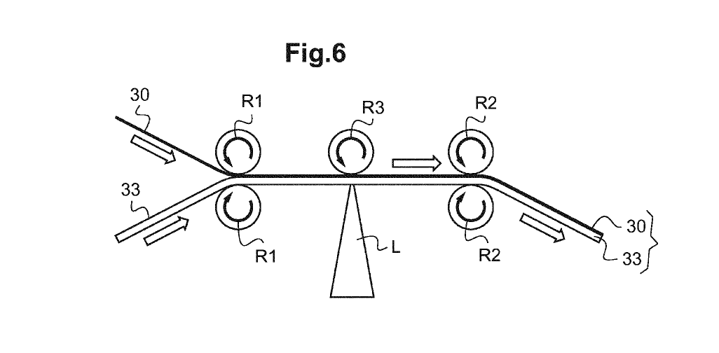

FIG. 6 is a schematic view of an advantageous variant of a step of the process, consisting in simultaneously and continuously unwinding an electrode metal foil and a strip of metal foam, in bonding them and then in welding them to each other

It will be noted that elements that are the same in an accumulator according to the prior art and in an accumulator according to the invention have been referenced by the same references for the sake of clarity.

It will be noted that the various elements according to the invention are shown only for the sake of clarity and that they are not to scale.

FIGS. 1 to 4B have already been commented upon in detail in the preamble. They are therefore not described below.

To improve the electrical connection between an electrochemical bundle of a Li-ion accumulator and its output terminals, the inventors have developed a new process for producing the electrochemical bundle.

The metal foils bearing the electrode materials may have a thickness comprised between 5 and 50 μm. For an anode foil 3, it may advantageously be a question of a foil made of copper of thickness of about 12 μm. For a cathode foil 2, it may advantageously be a question of a foil made of aluminium of thickness of about 20 μm.

The various steps of this production process according to the invention will now be described with reference to FIGS. 5 to 5D.

It will be noted that the process is described fully for an anode 3. The process also applies in the same way to a cathode 2. It is also possible to choose to produce an electrochemical bundle F and its electrical-connection portion only to the anode 3 using the process according to the invention, the production and the portion connecting to the cathode 2 possibly being carried out/produced using an existing process, and vice versa.

An anode 3 the metal foil of which bears, in its section 31, lithium insertion materials 32, whereas its lateral end band (margin) 30 is bare, i.e. devoid of lithium insertion materials, is started with (FIG. 5).

Step a/: At the end of the margin 30, to a face 31 thereof, a strip of metal foam 33 is welded (FIG. 5A). The metal foam 30 may advantageously be made of copper or any other compatible material such as nickel, steel, etc.

By way of variant, a strip of metal foam 33 may be welded at the end of he margin 30 to each of its faces 21 (FIG. 5′A).

Step b/: The anode 3, the cathode 2 and at least one separator film of the electrochemical cell C are then wound around a holder (not shown).

The bundle therefore has a cylindrical shape that is elongate along a longitudinal axis X, with, at one 10 of its lateral ends, uncoated bands 30 of anode 3, and, at the other 11 of its lateral ends, uncoated bands 20 of cathode. The initial bundle according to the invention is therefore such as shown in FIGS. 4 to 4B, with in addition, at the end of the margins 20, 30, strips of metal foam 23, 33 (FIG. 5B).

As may be seen in FIG. 5B, the thickness of the strip of foam 23, 33 is chosen initially to sufficiently fill the space between two spool turns during the winding of the bundle F.

Step c/: at one 11 of the lateral ends of the bundle, the plinth 23ₛ formed by the strip of foam 23 of the cathode (positive margins) is then laser welded L to a conventional current collected 24 taking the form of a solid disc (FIG. 5C) itself intended to be subsequently welded to the bottom 8 of the accumulator casing 6.

At the other 10 of the lateral ends of the beam, the plinth 33ₛ formed by the strip of metal foam 33 of the anode (negative margins) is laser welded in the same way to a conventional current-collector portion 34 taking the form of a solid disc drilled in its center and a tab (not shown) that protrudes laterally from the disc (FIG. 5C), the tab itself being intended to be welded to the negative output terminal 50 that is, mounted in such a way as to pass through the cover 9 of the accumulator casing.

The strips of metal foam 23, 33 form ends that are sufficiently dense to accept laser welding. The heat delivered by the welding may spread and avoid burning the collectors, while creating a good quality electrical joint.

FIG. 6 shows an advantageous variant of the production process according to the invention, in which step a/ is carried out prior to and continuously with the step b/ of spooling.

More precisely, a strip 30 of metal foil of an electrode, here the anode 3, is unwound simultaneously and continuously in parallel with the unwinding of a strip of metal foam 33, by means of drive rollers R1, R2.

The two strips 30, 33 are bonded to each other on passing through first drive rollers R1 and then they are unwound conjointly against a roller R3 that fauns a welding anvil. Facing this welding anvil R3 is arranged a laser beam L that may either produce a continuous line throughout the unwinding of the strips 30, 33 or a succession of pulses or even a salvo of laser pulses. The laser beam may advantageously be controlled depending on the speed at which the electrode strip 30 is unwound.

It is possible to proceed in the same way with the other electrode, i.e. the cathode 2.

Once the welding has been carried out, the two strips 30, 31 that have been welded to each other are conveyed, for conjoint winding thereof, by the drive rollers R2.

Other variants and improvements may be made without however departing from the scope of the invention.

The invention is not limited to the examples described above; it is in particular possible to combine features of the illustrated examples together in variants that have not been illustrated.

1. A process for producing an electrochemical bundle of a metal-ion accumulator, with a view to its electrical connection to output terminals of the accumulator, the process comprising:
a) welding a strip of metal foam to at least one face of one or more uncoated bands of an anode, a cathode, or both of at least one electrochemical cell comprising the cathode and the anode on either side of a separator suitable for being impregnated with an electrolyte; and
b) winding upon itself by spooling, the electrochemical cell until an electrochemical bundle having a shape that is, elongate along a longitudinal axis X is faulted with, at one of its lateral ends, uncoated bands of the anode, and, at the other of its lateral ends, uncoated bands of the cathode, the one or more metal foams welded to the one or more faces of the one or more bands and that are adjacent to one another forming a substantially flat plinth that is intended to be welded to a current collector.

2. The process for producing an electrochemical bundle as claimed in claim 1, wherein the welding a) and the winder b) are carried out continuously, with the welding a) being carried out prior to the winding b).

3. The process for producing an electrochemical bundle as claimed in claim 1, wherein the welding a) occurs by electric, laser or ultrasonic welding.

4. The process for producing an electrochemical bundle as claimed in claim 1, wherein, the welding a) occurs by spot welding or welding along a continuous path.

5. The process for producing at electrochemical bundle as claimed in claim 1, wherein, the one or more strips of foam are made of the same metal as that of the uncoated bands to which they are welded.

6. The process for producing an electrochemical bundle as claimed in claim 1, wherein a strip of metal foam is welded to each of the two faces of the uncoated band(s) of the anode, the cathode, or both.

7. The process for producing an electrochemical bundle as claimed in claim 1, further comprising:
c) performing an axial compression along the X-axis of the bands of the electrochemical bundle, in at least one area comprising the one or more strips of metal foam at the end of the uncoated bands so as to obtain, in the compressed area portion, the substantially flat plinth intended to be welded to a current collector.

8. A process for producing a portion for electrical connection between an electrochemical bundle of a metal-ion accumulator and one of output terminals of the accumulator, the process comprising:
producing an electrochemical bundle (F) by the process of claim 1:
welding each plinth formed by the one or more strips of metal foam to a current collector intended to be electrically connected or joined to an output terminal of the accumulator.

9. The process for producing a portion for electrical connection as claimed in claim 8, wherein the welding of a plinth to a current collector occurs by laser welding.

10. A metal-ion accumulator or battery, comprising:
a bottom to which is welded one of current collectors welded to a electrochemical bundle produced by the process of claim 8; and
a cover with a feedthrough forming an output terminal to which is welded the other of the current collectors welded to the electrochemical bundle.

11. The lithium-ion accumulator or battery as claimed in claim 10, wherein:
the material of the negative electrode(s) is selected from the group consisting of graphite, lithium, and titanate oxide Li₄TiO₅O₁₂; or is based on silicon or is based on lithium, or is based on tin and alloys thereof
the material of the positive electrode(s) is selected from the group consisting of lithium iron phosphate LiFePO₄, lithium cobalt oxide LiCoO₂, optionally substituted lithium manganese oxide LiMn₂O₄, a material based on LiNiₓMn_{y}Co_{z}O₂ where x+y+z=1, a material based on LiNiₓCo_{y}Al_{z}O₂ where x+y+z=1. LiMn₂O₄, LiNiMnCoO₂, and lithium nickel cobalt aluminium oxide LiNiCoAlO₂.
